(19) United States
(12) Patent Application Publication
(10) Pub. No.: US 2009/0100323 A1
(43) Pub. Date: Apr. 16, 2009

(54) LINK GENERATOR

(75) Inventors: Chris Walls, Bloomington, IN (US); Alex Zlotin, Bloomington, IN (US); Prem Radhakrishnan, Bloomington, IN (US)

Correspondence Address: DAVID L. KING, SR., 5131 N.E. COUNTY ROAD 340, HIGH SPRINGS, FL, 32643, US

(73) Assignee: 39 DEGREES NORTH, LLC, Bloomington, IN (US)

(21) Appl. No.: 12/247,484

(22) Filed: Oct. 8, 2008

Related U.S. Application Data
(60) Provisional application No. 60/978,908, filed on Oct. 10, 2007.

(51) Int. Cl. G06F 17/00

(52) U.S. Cl. 715/206

(57) ABSTRACT

A method of linking digital text based electronically stored documents to geographical spatial maps has the steps of compiling a group of digital text documents; and providing a link creator, the link creator generates hyperlinks in the digital text documents relating to a location or a structure and connecting the generated hyperlinks to geographic features or locations in a mapping application. The method further includes the step of identifying keywords or phrases in the digital text documents; creating a direct link between the keyword or phrase and the geographical location or feature on the map application and searching a keyword or phrase in the digital text documents to create a subset of documents containing the keyword linked to a geographical feature or location. The link generator has a computer generated hyperlink creator program for generating hyperlinks in digital text documents and connecting the hyperlink to geographic features and locations in digital mapping applications.

### RELATED APPLICATIONS

This application claims benefit of priority to provisional application Ser. No. 60/978,908 filed Oct. 10, 2007 entitled “Link Generator”.

### FIELD OF THE INVENTION

This invention relates to a method for navigating between geographical spatial mapping applications and digital text documents.

### BACKGROUND OF THE INVENTION

Historically digital maps are provided with software applications that enable the user to visualize specific locations on a map and certain features within those maps such as roads and railways and structures. These digital maps are commonly used in an attempt to find a specific location or address and then providing means to getting directions to and from geographical locations by showing the route on the map. In such applications, the user is provided with a map that enables the user to move the entire map directionally and to enlarge or shrink the size of the map. Beyond that the interface within the map is generally quite limited. Additionally, these maps, besides providing driving directions and locations of features, also can be used in such applications as weather forecasting. In those applications the end user can type in a geographical zip code and the digital geographic map will appear indicating the weather conditions. In this weather map, radar applications are often shown in motion moving across the map. Again these maps can be increased size or moved left to right to change directions within the map at the discretion of the user.

What is sorely lacking in geospatial geographical mapping applications is the ability to circumvent between a spatial map and text documents. In the US Patent Office when searching for patents, digital text documents can be word searched from 1976 forward and older US Patents are only maintained as an image file. As a result of this, navigation word searching the image file is virtually impossible and therefore can only be searched by use of a sophisticated classification system.

In the use of maps, a similar problem exists, the map itself provides excellent views of features and can provide satellite imaging of features, however, in such situations there is no ability to navigate between the map and any text documents relating to these features.

The present invention provides a solution to this problem that is quite beneficial and particularly useful in areas such as emergency management systems, such as fire, ambulance and law enforcement. The following description in the present patent application provides a unique method of navigating between geographical spatial maps and digital textual documents. These features greatly enhance the ability of first responders coming to an emergency situation. By way of example, when approaching a building containing hazardous materials it is quite beneficial for the first responders in an emergency team to understand what is precisely contained within that structure. The present application will provide this capability to first responders in a real time useful application that can be used with or in the absence of internet access.

### SUMMARY OF THE INVENTION

A method of linking digital text based electronically stored documents to geographical spatial maps has the steps of compiling a group of digital text documents; and providing a link creator, the link creator generates hyperlinks in the digital text documents relating to a location or a structure and connecting the generated hyperlinks to geographic features or locations in a mapping application. The method further includes the step of identifying keywords or phrases in the digital text documents; creating a direct link between the keyword or phrase and the geographical location or feature on the map application and searching a keyword or phrase in the digital text documents to create a subset of documents containing the keyword linked to a geographical feature or location. The method when practiced by an end user further has the steps of providing users at a desktop or laptop computer independent of external internet access with a geographical spatial map viewer application; accessing the map to locate a location or a feature; providing hyperlink buttons to enable the user to show a list of text documents with a hyperlink to the location or feature; and providing access to the specific text document in the list by clicking on that text document. A text document when opened highlights the keyword or phrase within each text document. A toolbar to facilitate navigating between geographical spatial maps and text documents related to a location or a feature on the map is provided. The link generator has a computer generated hyperlink creator program for generating hyperlinks in digital text documents and connecting the hyperlink to geographic features and locations in digital mapping applications.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a view of a hyperlink toolbar image of the present invention.

FIG. 2 is a view of a hyperlink creator page of the present invention.

FIG. 3 is a view of the keywords tab.

FIG. 4 is a view of the documents tab.

FIG. 5 is a view of a geographical map with a show documents for enabling text linked document to be viewed.

FIG. 6 is a view of the geographical map with the linked text documents shown as layers in the left hand column.

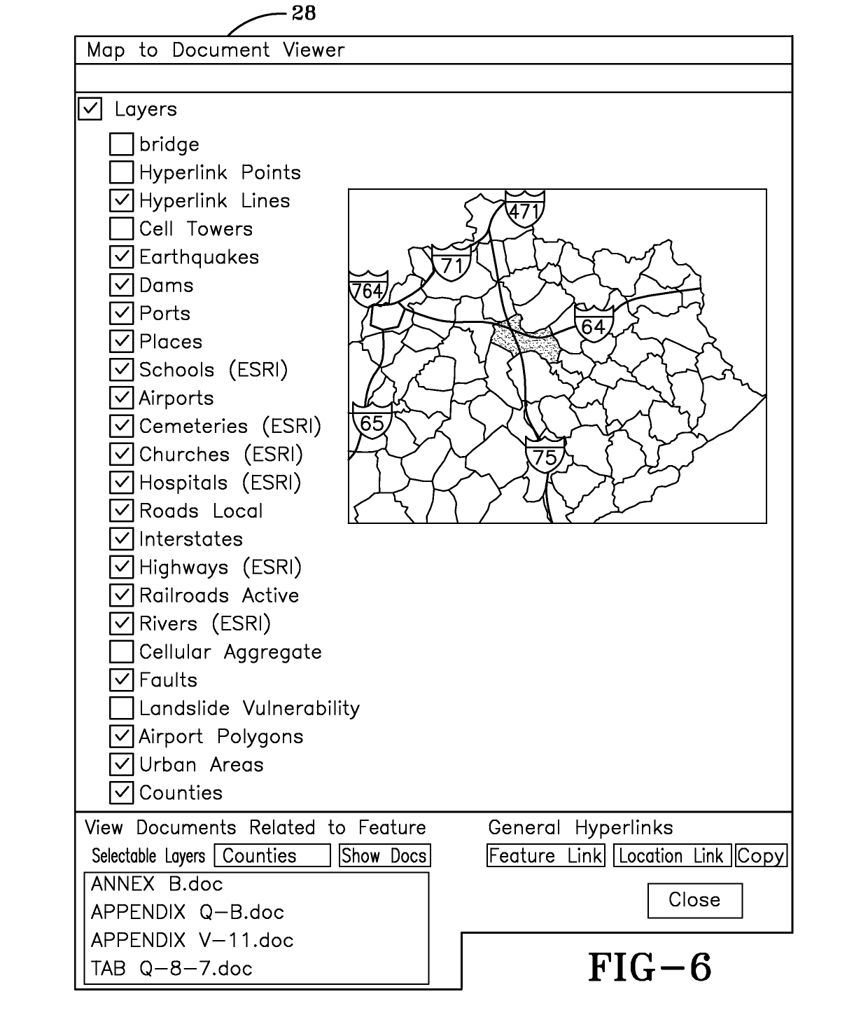

### DETAILED DESCRIPTION OF THE INVENTION

As previously noted, the present invention has a highly desirable capability to provide real time information to emergency and security personnel.

Emergency preparedness, whether at the Federal, state, or local level depends on detailed and effective Emergency Operations Plans (EOPs). The DHS and FEMA describe the EOP as “the centerpiece of comprehensive emergency management.” One obstacle to the timely utilization of EOPs, however, is their length: a typical state, city or county EOP might consist of a central outline plus as many as 30 separate annexes, sometimes amounting to hundreds of pages, which can hinder as much as help decision-makers in their attempts to understand the impact of a natural or man-made disaster, visualize their options, and implement solutions. The present invention includes the use of Spatial Infrastructure Support System (SISS™), a set of software tools that integrate and spatially enable EOPs by linking them to a Geographic Information System (GIS). SISS™ will bring the collectors and processors of geospatial intelligence into direct contact with the decision-makers who interpret EOPs, thereby improving the dissemination, visualization, analysis, and sharing of information throughout the Emergency Operations Center (EOC).

This invention was developed by an internationally recognized team of GIS experts who have demonstrated their ability to create cutting-edge custom applications and design complex enterprise systems. This team of inventors has a history of concept development and expertise in implementation, including the enhancement of RAID (Rapid Aerostat Initial Deployment), which is being used by the United States Army. The RAID system is currently deployed to support troops in Iraq and Afghanistan. The existing system is a combination of cameras and surveillance equipment positioned on high towers and tethered, unmanned blimps. The inventors drew on their long-standing relationships and experience in supporting DOD applications and their footprint throughout the homeland security community to ensure that SISS™ meets the objectives and strategic goals of the EOC.

The inventors have created SISS™ and its methods for use by the local and state governments. SISS™ promotes the effective usage of EOPs by extracting geographical references from EOPs' high-volume, often loosely structured textual data and hyperlinking them to their visual representations in an interactive GIS mapping application. Links generated in the EOP documents (to National Guard facilities, emergency shelters, or hospitals, for example) will click through to their positions on the electronic map, and those features on the map will connect users back to the relevant portions of the documentation. These 2-way linkages between geospatial data and the pertinent text in the corresponding EOPs will allow planners to identify gaps in response coordination between local, county, and state plans, and to maximize information integration. During the most critical and stressful moments immediately following a security-related incident, the agencies responsible for executing EOPs will be able to engage in rapid visualization of the geography of the situation and to share data quickly and easily. The resultant fused intelligence will allow them to assess the impact of natural disasters and man-made hazards on their ability to implement a proposed solution, and to respond with optimal efficiency.

GIS layers to be used in SISS™ may include, but are not limited to: Emergency operations centers, Essential infrastructure and utilities, Emergency shelters, Key government buildings, Evacuation routes, National Guard and Reserve facilities, Evacuation zones, High-hazard dams, Evacuation assembly centers, Natural Hazards, High-capacity venues, Hospitals/trauma centers, HAZMAT facilities, Blood banks

SISS™ consists of two ArcEngine administrative tools, Link Creator and Map Viewer Desktop, as well as an ArcGIS Server map viewer for all users. The Link Creator generates the aforementioned hyperlinks between relevant geographic features and corresponding keywords in the Microsoft Word documents that make up EOPs. Configuration files can be set up to direct the Link Creator to highlight specific words or phrases, or to process a subset of documents, rather than automatically mining the entire data set.

The Map Viewer Desktop portion of SISS™ is launched as a Windows application and can be used as either an administrative or end-user utility. From an end-user perspective, this tool can be used locally on a desktop or laptop independent of internet connectivity. A layer of interest and features in this layer can be selected. Clicking the “Show Documents” button will return a list of documents which contain hyperlinks to this feature. Hyperlinks in documents opened from Map Viewer Desktop can be navigated with Previous and Next Hyperlink buttons embedded in a custom Word toolbar. These buttons allow the user to loop through all hyperlinks which point to a selected feature. From the administrative perspective, Map Viewer Desktop allows administrators to create spatial hyperlinks for features or locations. After a spatial hyperlink has been generated, the link is copied and a word or phrase is highlighted in the Word document and a custom button is used to create a spatial hyperlink. Additionally, hyperlinks in the document can be deleted using a separate button on the custom toolbar in Word.

Map Viewer Web is an ArcGIS Server web application running in a browser. The application is launched from a hyperlink in a Word document or URL and zooms the map to the hyperlinked feature. The feature is highlighted and its attributes are shown. The Show Documents button returns a list of documents which contain hyperlinks to this feature. Additional tools included with Map Viewer Web are listed below: Attribute Viewer—Displays feature attributes in an ArcMap-style table. Attribute selections are synchronized between the table and the map. Bookmark—Saves maps, storing extents and layer visibility in cookies. Export Map—Exports maps to image files (optionally with a world file) and sends them by e-mail. Extract Data—Extracts vector and raster data from a specified area and selected layers of a map resource. Identify Features—Displays identify results in a configurable ArcMap-style window. Markup—Creates and manages graphic shapes and text. The graphics can be saved to XML or a file geodatabase, or added to maps from XML files. Print Map—Allows to configure map layouts and generate output in the PDF format. Query Features—Enables query construction with a query builder and displays results in a configurable window. Search—Executes pre-defined queries against map layers and displays results in a configurable window. Symbolize Features—Dynamically symbolizes and labels features in a selected layer based on a specified field.

Software Requirements to use the SISS™ system preferably include: ArcGIS Desktop for publishing map documents; ArcGIS Server Standard or Advanced (Workgroup or Enterprise) for creating deploying web applications; and ArcGIS Engine for custom data management applications.

SISS™ is a toolset used for the creation, maintenance, and navigation of spatial hyperlinks. SISS™ provides linkages from digital documents to digital maps, and from digital maps to digital documents. SISS™ scans documents for words that match the names of geographic features in a spatial dataset, and creates hyperlinks between the two. Clicking on a hyperlink launches a web mapping application, zooms to the feature on the map, and highlights it. Users can also access all documents related to a specific geographic feature simply by finding it on the map, and clicking on it.

Link Creator: The Link Creator generates hyperlinks in digital documents, connecting them to geographic features in a mapping application. The Link Creator tool also highlights words that indicate non-specific geographic locations, such as a street name without an address, and alerts the administrator to the need for a manually created link.

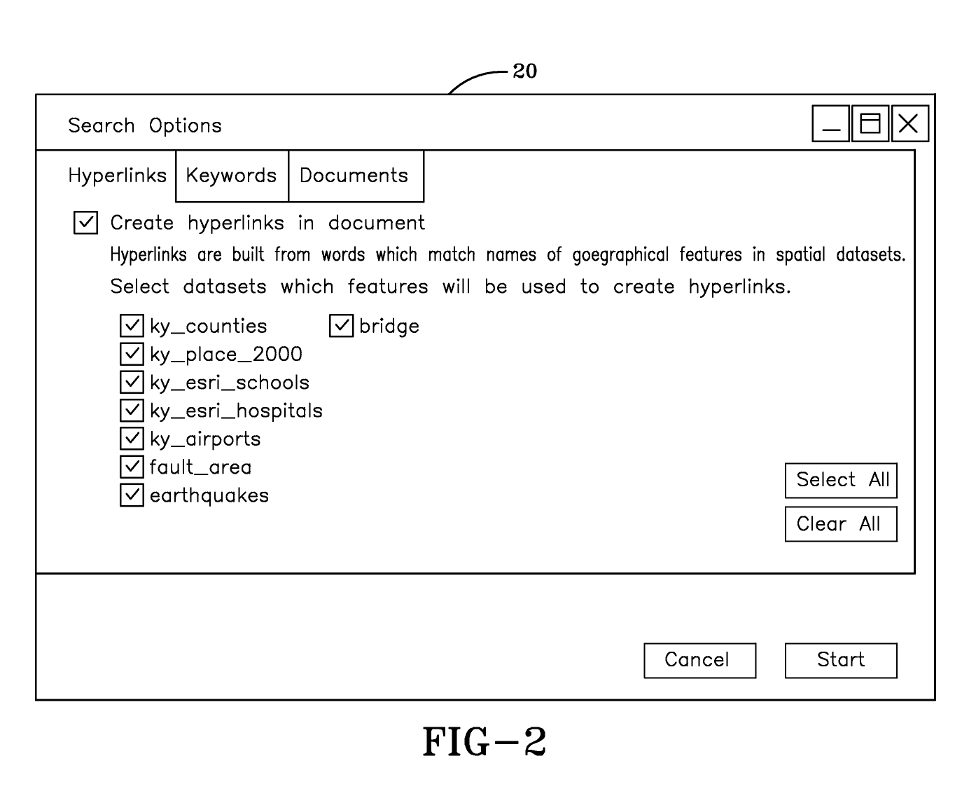

“Hyperlinks” tab: The administrator initially launches the SISS™ automated Hyperlink Creator (see FIG. 2). He then sets the appropriate parameters in three separate tabs (Hyperlinks, Keywords, and Documents). The “Hyperlinks” tab is used to select the spatial datasets that will be linked to the geographic features in the document.

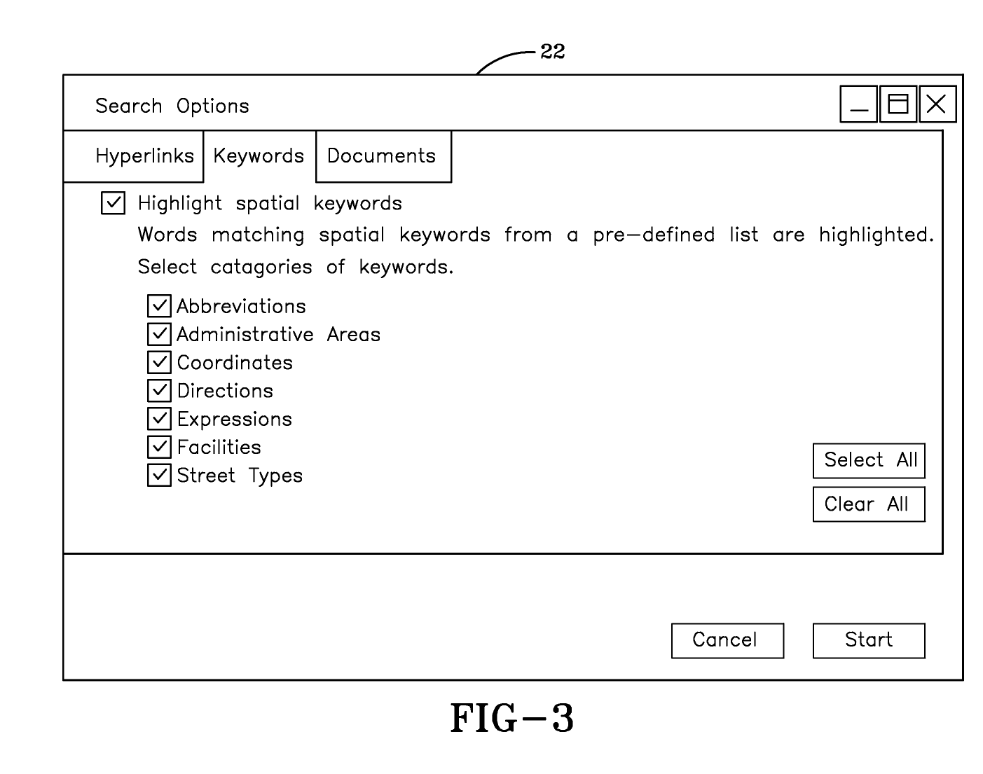

“Keywords” tab: The “Keywords” tab takes the non-specific geographic features (those which did not generate hyperlinks from the document) and highlights them for manual review. (see FIG. 3)

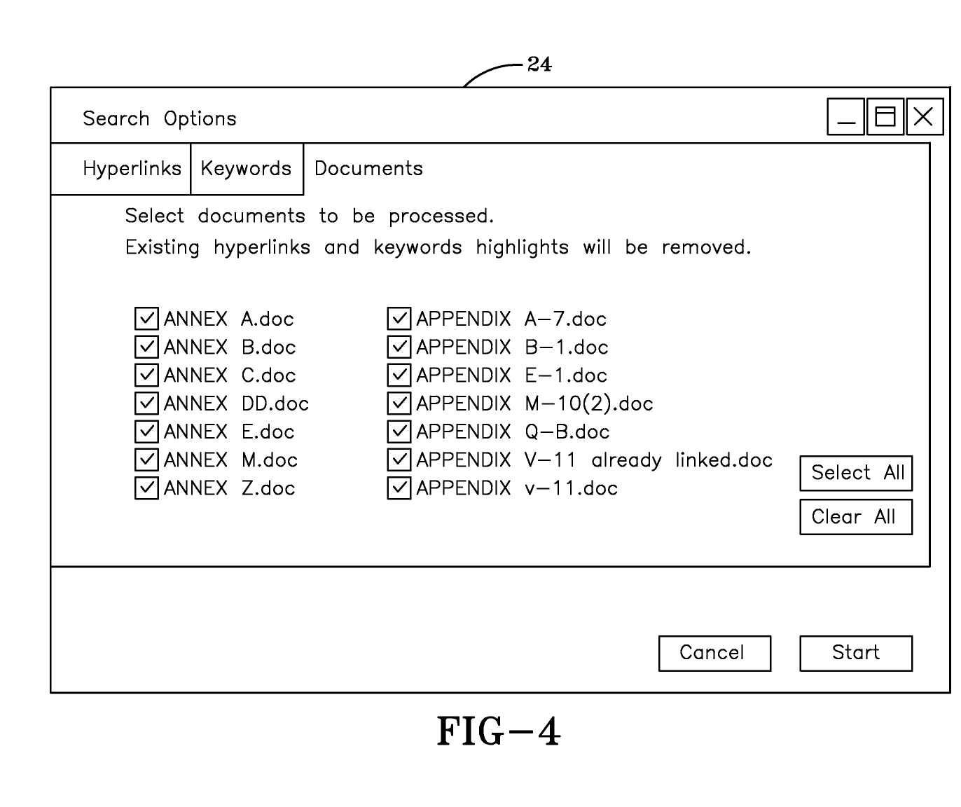

“Documents” tab: The “Documents” tab allows a user to specify the folders and subfolders whose documents will be processed by the Link Creator. (see FIG. 4)

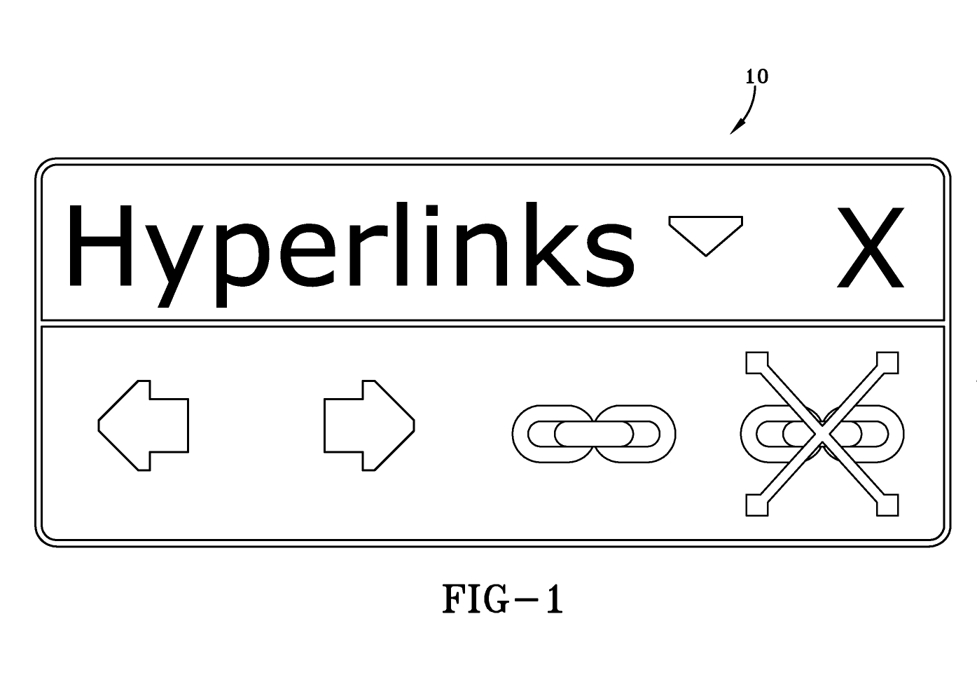

Processed Documents: Data administrators can review the generated hyperlinks and highlighted spatial keywords with the assistance of a maintenance tool which allows the creation, deletion, or updating of hyperlinks in manual mode (see FIG. 1).

Hyperlinks Toolbar includes the following buttons: 1) previous link 2) next link 3) create link and 4) delete link.

Web-based Map Viewer: Spatial hyperlinks launch web-mapping applications and display related geographic objects. The web application allows users to select an arbitrary geographic feature and generate a list of all documents in which the feature is referenced.

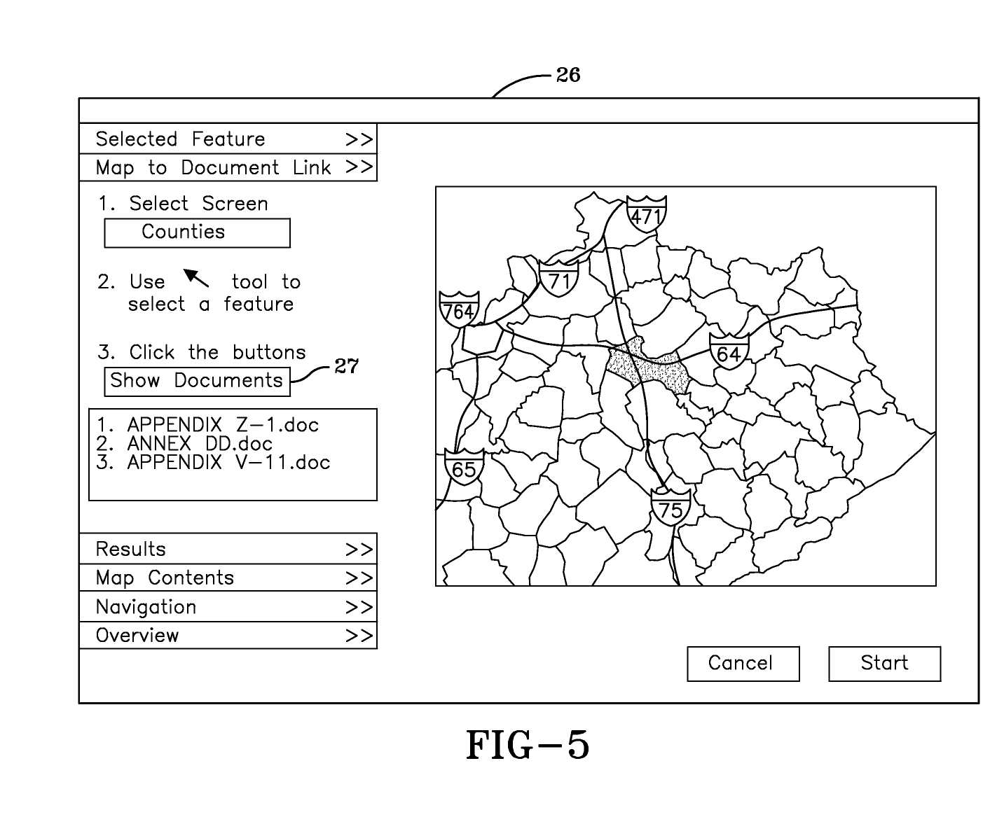

The Map-to-Document Link function allows users to select a layer of interest and a feature within this layer. The Show Documents button returns a list of documents which contain hyperlinks to this feature. (see FIG. 5)

Desktop Map Viewer: This stand-alone Windows application allows users to navigate among the hyperlinks in the documents related to the feature selected on the map. For example, if a user has chosen “Monroe County” on the map, the Desktop Map Viewer will show him not only every document in which that feature occurs, but every occurrence of that feature in each document.

The inventive method as claimed in this patent application is preferably used in combination with pre-existing software applications such as Microsoft Word; ArcGIS and other known software applications.

It is the novel methods of use in this application and the capabilities it discloses that represent a gigantic leap forward in data and information retrieval and access.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of linking digital text based electronically stored documents to geographical spatial maps comprises the steps of:
compiling a group of digital text documents; and
providing a link creator, the link creator generates hyperlinks in the digital text documents relating to a location or a structure and connecting the generated hyperlinks to geographic features or locations in a mapping application.

2. The method of claim 1 further comprises the step of:
identifying keywords or phrases in the digital text documents; creating a direct link between the keyword or phrase and the geographical location or feature on the map application.

3. The method of claim 2 further comprises the step of:
searching a keyword or phrase in the digital text documents to create a subset of documents containing the keyword onto a geographical feature or location.

4. The method of claim 1 further comprises the steps of:
providing users at a desktop or laptop computer independent of external internet access with a geographical spatial map viewer application;
accessing the map to locate a location of a feature;
providing hyperlink buttons to enable the user to show a list of text documents with a hyperlink to the location or feature; and
providing access to the specific text document in the list by clicking on that text document.

5. The method of claim 4 wherein a text document when opened highlights the keyword or phrase within each text document.

6. The method of claim 1 further comprises the step of:
providing a toolbar to facilitate navigating between geographical spatial maps and text documents related to a location or a feature on the map.

7. A link generator comprises:
a computer generated hyperlink creator program for generating hyperlinks in digital text documents and connecting the hyperlink to geographic features and locations in digital mapping applications.
